(19) United States
(12) Patent Application Publication
(10) Pub. No.: US 2007/0263626 A1
(43) Pub. Date: Nov. 15, 2007

(54) A System for Session-Oriented Reliable Multicast Transmission.

(76) Inventor: David Matthew Warden, Champaign, IL (US)

Correspondence Address: DAVID WARDEN, 4104 MANOR CT., CHAMPAIGN, IL, 61822, US

(21) Appl. No.: 11/383,204

(22) Filed: May 14, 2006

(51) Int. Cl. H04L 12/56; H04J 3/26

(52) U.S. Cl. 370/390; 370/432

(57) ABSTRACT

The present invention is a system for reliably and efficiently transmitting data shared among several computers simultaneously. The system makes use of concurrent multicast and unicast connections following a server-controlled session-oriented protocol. By using the system support for late-joining is available, and repairs after long connectivity losses can be made. Additionally, the system can limit transmission of repair data to intended recipients of that particular information.

### OTHER REFERENCES

Speakman et al., “RFC 3208 PGM Reliable Transport Protocol Specification”, IETF RFC Publication, December 2001.

U.S. Patent Documents

| | | | |
|---|---|---|---|
| 4,807,224 | February 1989 | Naron, et al. | 370/218. |
| 5,109,384 | April 1992 | Tseung | 714/748. |
| 5,754,754 | May 1998 | Dudley, et al. | 714/18. |
| 5,905,871 | May 1999 | Buskens, et al. | 709/245. |
| 6,112,323 | August 2000 | Meizlik, et al. | 714/748. |
| 6,226,686 | May 2001 | Rothschild, et al. | 709/245. |
| 6,392,993 | May 2002 | Hamilton, et al. | 370/230. |
| 6,581,175 | June 2003 | Crump, et al. | 714/748. |

### DESCRIPTION

### Background of the Invention

1. Field of the Invention

The invention pertains to systems for transmitting data to multiple computers simultaneously.

2. Description of the Prior Art

In collaborative or presentation applications, it is common to send identical data to several computers simultaneously. IP multicast packets provide a basic means to do so, however it is challenging to make multicast transmissions reliable. Reliability in this case means that data is received by the application exactly once and in a particular order.

Protocols such as Pragmatic General Multicast (PGM) provide some reliability through forward error correction and selective retransmission of packets based on negative acknowledgements. There are several limitations of the PGM and related protocols. One limitation is that they do not provide a means to send all packets to a client who may join an application session late.

A second limitation is that such protocols lack a means to identify those clients which do not need a particular packet so that it need not be retransmitted if it is missing only by them. This is important, for example, in a wireless environment where it is efficient to multicast a packet used only by six of thirty computers participating in a session as it will reduce traffic by approximately five-sixths as compared with resending the same information to each of the machines in series. If such a packet needs to be processed in an order consistent with packets sent to all machines, it must be sent to the same multicast group as that to which packets destined for all machines are sent, or additional serialization logic must be employed. Hence, under PGM all thirty machines would expect to receive the packet, and if any among the twenty-four for whom it was not destined do not receive it, they will request a retransmission that could have been avoided under a more ideal protocol. This is a problem for any retransmission scheme which is not sender-controlled, as the client can not determine the intended recipient of a piece of data without examining it.

Since a sender-controlled scheme requires the sender know something about its client; this leads us to a third limitation of PGM and existing multicast protocols: they are not session-oriented. In contrast to lower-level protocols, session-oriented protocols may maintain state information and individual bidirectional connections among senders and recipients. This allows for retransmission of data even after an unusually long connectivity failure, during which a PGM socket would become invalid. Naturally, such information can be used in conjunction with the individual connections to send all data to late joiners, and limit the repair information to intended recipients.

Session-oriented protocols may allow data to be retransmitted using the typical TCP positive-acknowledgement based scheme, which is more efficient in such situations where only a single client may need a particular piece of information at a particular time. To facilitate this without delaying other clients, session-oriented protocols need a mechanism to accept and serialize data from multiple streams simultaneously, a feature lacking in the prior art.

### SUMMARY OF THE PRESENT INVENTION

The invention is a system for efficiently and reliably transmitting session-oriented information among several clients simultaneously. In an embodiment of the invention each client using the system connects to a server and joins a session. While part of a session each client attempts to maintain a connection to a multicast group as well as a unicast connection to the server. The clients transmit data meant for the session over their unicast connection to the server where it is assigned a sequence number and serialized. The server then transmits the data to the members of the session via multicast and provides repairs via unicast when necessary. Once the clients receive the data it is passed to the application in sequence.

The individual clients operate in either unicast mode or multicast mode. Clients begin in unicast mode and transition to multicast mode when they successfully join a multicast group. Upon connection or reconnection clients transmit an indication of the data they have received, if any. The server responds by sending any old or repair data intended for the client over its unicast connection. This solves the problem of late joining and reduces the need for unnecessary retransmissions. Asynchronous data intended for the client may also be sent over the unicast connection at any time.

In unicast mode, the session data currently being transmitted is sent to the client over its unicast connection as it is sent to the multicast group. This data is buffered until any old or repair data is processed by the application. Upon transition to multicast mode current data received via multicast is buffered until the server is notified and it stops sending this data via unicast.

Heartbeat messages, along with the underlying socket interfaces are used to detect connectivity problems. If the membership in the multicast group can not be maintained, the client may revert to unicast mode, in which case data is sent as described previously. If the connection is lost entirely, the client may attempt reconnection, and if successful follow the same process as it did with the initial connection. Operation continues until the session is terminated.

### BRIEF DESCRIPTION OF THE DRAWINGS

FIG. 1 is a diagram illustrating the general means of participation of computers in a session using the system.

FIG. 2 is a diagram illustrating an example of the operation of the system immediately following the establishment of a connection.

FIG. 3 is a diagram illustrating an example of the operation of the system in transition from unicast mode to multicast mode.

FIG. 4 is a diagram illustrating an example of the operation of the system in transition from multicast mode to unicast mode.

FIG. 5 is a diagram illustrating an example of the operation of the system following reestablishment of a connection after a temporary loss of connectivity.

### DETAILED DESCRIPTION OF THE INVENTION

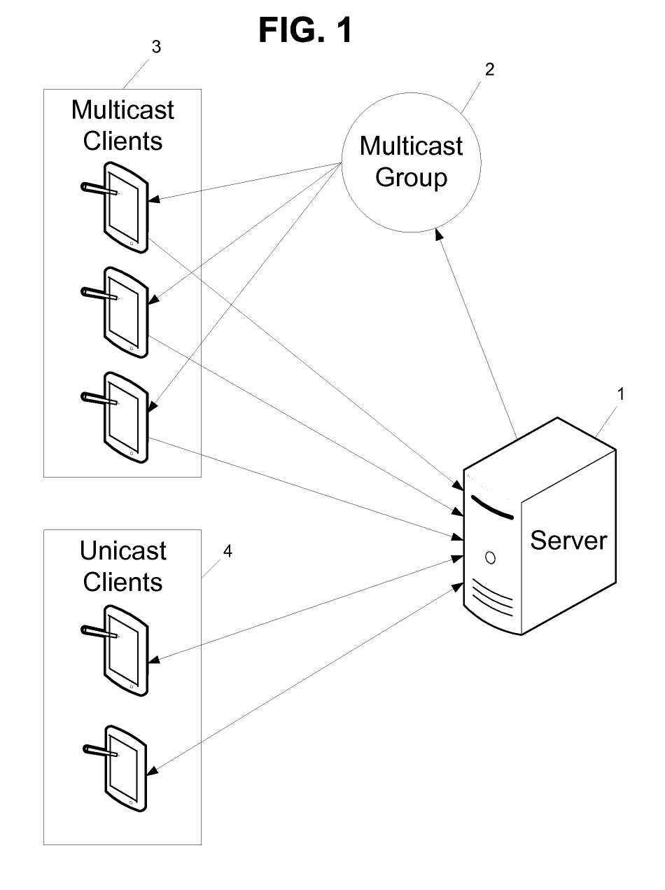

An overview of the operation of the system is shown in FIG. 1. The system includes one or more clients and a server 1 participating in a shared data session which exchange data messages used by one or more application programs. The sessions may be located by supplying the address of the server or by means of a session announcement protocol. Creation, deletion, and general management of sessions may be performed by sending commands to the server software over the network, using a management console, or by an automated, pervasive computing environment aware of a need for a session management operation, such as the creation of a session for a scheduled class or conference at the appointed time.

The messages exchanged may be in binary, XML, or another representation. The messages may be compressed, fragmented, encrypted, digitally signed, or some combination thereof. Messages contain a sequence number and/or a timestamp. Messages may specify a destination or set of destinations in the form of particular clients, users, roles, or some combination thereof, including the destination consisting of all clients participating in the session. The members of the sets of destinations may change while the system is in operation.

The system uses a server 1 although the server 1 need not be a dedicated machine, but can also be chosen among client systems in a peer-to-peer operation and can operate on any computing device with network support and sufficient storage to hold the session's messages.

Similarly, clients can operate on a variety of hardware. While a wireless Tablet PC client is typical, clients may also be PDAs, notebook computers, desktop PCs, server machines, or other devices. Clients may be generally categorized as multicast clients 3 or unicast clients 4, although clients may switch between these operating modes several times during a session. Clients may join or leave at any time due to an intentional operation or connectivity problems.

All clients send data to the server via a unicast connection using a protocol such as TCP/IP. On the server the data is serialized and may be authenticated or processed in an application-specific manner. The unicast clients 4 also receive all information directly with the server over their unicast connection. The server only forwards messages to a particular unicast client when that client is included in the list of destinations of the message.

The multicast clients 3 receive their data through a multicast group 2. A multicast group 2 is created whenever at least two distinct clients have joined the session at any point in time. The multicast session may be a PGM session or use any related protocol. The multicast address may be generated randomly, allocated using a protocol such as the Multicast Address Dynamic Client Allocation Protocol, or be administrated through some other means. Packets are transmitted to the multicast session whenever a destination of the message is other than a particular unicast mode client. Clients that are not in unicast mode may receive messages via multicast, including clients whose unicast connection has been lost, and if there is more than one client in the destination multicast is more efficient and should be attempted. If a message is transmitted that is designated as one to be transmitted on a best-effort basis, as order independent, and as destined only for a single client, it may be sent via unicast even if the client is a multicast client as it is more efficient and will be received unless the unicast connection is lost contemporaneously.

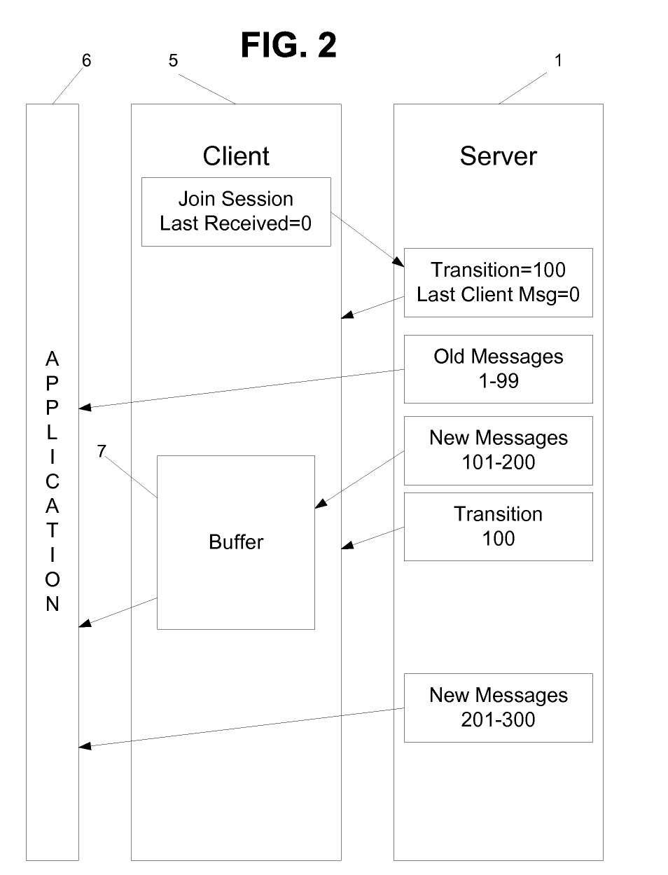

The system specifies a protocol for operation upon first connecting to the system, as exemplified in FIG. 2. First, the client 5 informs the server 1 of the sequence number of the last message it has received. Since the client has not received any messages, it uses the number zero which is reserved for this purpose; the sequence numbers of the actual messages begin with one.

Next, the server 1 responds with a sequence number reserved for a special transition message. It also responds with an indication of the last message it received from that client 5; as the server 1 received no such messages this is also zero.

The sequence number of the transition message is meaningful in several respects. Messages with sequence numbers ordered before that of the transition message consist of all previously transmitted messages intended for the client 5 in the correct order and may be processed immediately by the client 5 and passed on to the application program 6. In the example this is shown by the retransmission of the old messages 1-99. Messages with sequence numbers greater than that of the transition message are new messages and are stored in a buffer 7 until all the older messages have been processed. This receipt and buffering of new messages is necessary to allow the client 5 to become up-to-date and perhaps transition to a multicast mode where messages are received as they are generated; otherwise a gap between the last old message received and newest message sent may persist. The buffering process is shown in FIG. 2 with the transmission of the new messages 101-200. When the transition message itself is received, the client 5 is up-to-date and may immediately process all of the messages stored in the buffer 7 and send them to the application 6.

The computation of the transition message sequence number is critical to the proper operation of the system. The sequence number must be assigned such that the system insures all messages destined for the client 5 with a higher number are sent at the time they are generated, and those with a lower number are sent prior to the transition message. Such messages must be transmitted to a client 5 exactly once. In order to achieve this, transition sequence numbers must be obtained and sent, and clients must be added to the list of active unicast destinations after the transmission of prior messages has concluded and before the transmission of newer messages has begun.

The server 1 can not wait for any particular client to receive a message before transmitting messages to others without disrupting the performance of the system as a whole; therefore it must allow for concurrent processing of tasks. To insure that the concurrent tasks do not interfere with each other a mutual exclusion construct is used to prevent message transmission while transition sequence numbers are assigned. Additionally, buffers are used on the server 1 to insure that transmission of the transition sequence number does not delay release of the mutual exclusion construct. To avoid high contention over mutual exclusion constructs in the system, it is desirable to batch operations together, so that the construct need only be obtained and released once to transmit several messages. It is also important to insure that new messages are sent periodically and the mutual exclusion construct is not continually awarded for computation of transition sequence numbers, as could be the case if a client 5 continually disconnected and reconnected. Hence when operating, the server 1 will transmit a block of messages, compute sequence numbers for those clients waiting when the transmitting completed, and then transmit another block of messages.

After the client 5 is up-to-date, any new messages are processed immediately and sent to the application 6, as shown by messages 201-300 in FIG. 2. The client 5 sends any messages the application 6 generates for the session to the server 1 as they are generated.

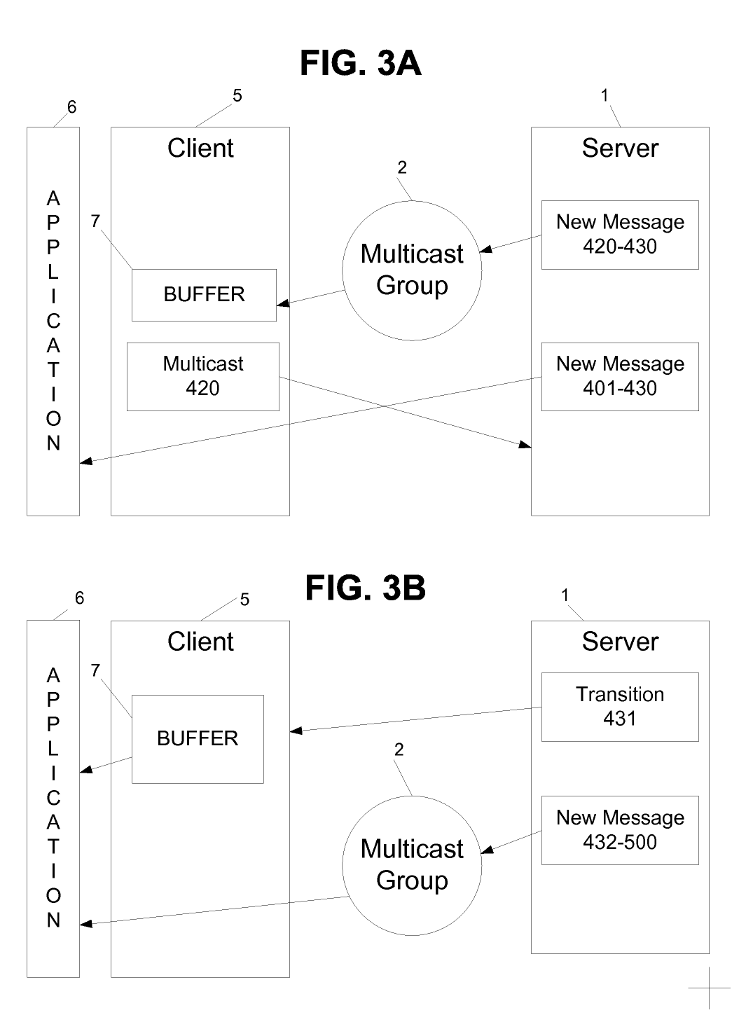

The operation of the system during the transition of a client 5 from unicast mode to multicast mode is shown in FIG. 3. The transition to multicast operation begins when a client first receives a multicast message. This is shown in FIG. 3A where the server 1 transmits messages 420-430 to a multicast group 2 which are received by a client 5 and stored in a buffer 7.

The first multicast message may be received at any time, including when a client is initiating its initial connection. The only difference in operation under such a circumstance is that if multicast messages are received by a client 5 prior to transmission of its first message joining a session, the client 5 sends the ranges of messages received via multicast to the server 1 upon connection and those messages are not retransmitted. The beginning of the range of sequence numbers received from the most recent continuous multicast connection serves as the transition sequence number, and a transition message with that number commences normal operation in multicast mode.

In any case, once multicast messages received by a client 5 the client responds with a message indicating the transition to multicast mode and the sequence number of the first multicast message received, which is message 420 in FIG. 3A. It is understood that the client 5 will receive all later multicast messages while a continuous connection to the multicast group 2 is maintained; otherwise the client 5 will need to transition back to unicast mode or reestablish the connection entirely.

Until the server 1 processes the transition to multicast mode, it will continue to send messages to the client 5 via unicast as in the case of messages 401-430 in FIG. 3A. Such unicast messages received may have sequence numbers lesser, greater, or overlapping those of the multicast messages. Messages in the buffer 7 can be discarded as unicast messages with equal or greater sequence number are processed, however creates higher contention for the buffer's synchronization constructs and is only necessary if memory space is at a premium. The unicast messages are processed by the client 5 and sent on to the application 6 as if the client 5 had not received any multicast messages. It is important these messages are used, as if a message were destined only for a particular client while in unicast mode it would not have been multicast.

When the server 1 processes the request to transition to multicast mode, it immediately moves the client 5 from the list of unicast clients to the list of multicast clients and sends a transition message with the sequence number of the first multicast message to use. This is shown with the transition message containing sequence number 431 in FIG. 3B. The server 1 will have already committed to sending all preceding messages via unicast to the client 5, however it is possible that subsequent messages will be sent via multicast, received by the client 5, and buffered before those unicast messages are received.

Once the transition message is received by the client, those messages in the buffer 7 having a lower sequence number than the transition message are discarded. Those messages with a higher sequence number are immediately processed by the client 5 and sent to the application 6. New messages received via multicast are immediately processed by the client 5 and sent to the application 6 as in the case of messages 432-500 in FIG. 3B.

Whenever a client 5, after beginning the transition to multicast mode, looses the connection with the multicast group 2 while retaining its unicast connection, it must begin a transition to unicast mode. The connection to a multicast group may be lost under several circumstances such as: interference with the physical transmission signal; excessive traffic which may or may not be related to the session in which a client 5 is participating; movement of a mobile client to a location supported by a different network infrastructure; or a temporary failure in the client, server, or network hardware or software.

The failure of the multicast group may be detected by an error reported by the multicast protocol support, or by the use of heartbeat messages which alert the client to a problem if they are not received at periodic intervals appropriate for the application. Such an interval should not be so frequent as to interfere with normal traffic or generate false error reports, nor so infrequent as to allow failures to become annoying to a user. Typically such messages are sent at intervals of a few seconds, and an error is reported if more than a few intervals pass without receiving any messages. Naturally, regular data, if there is any during a particular interval, can serve the purpose of a heartbeat message without the need for additional transmissions.

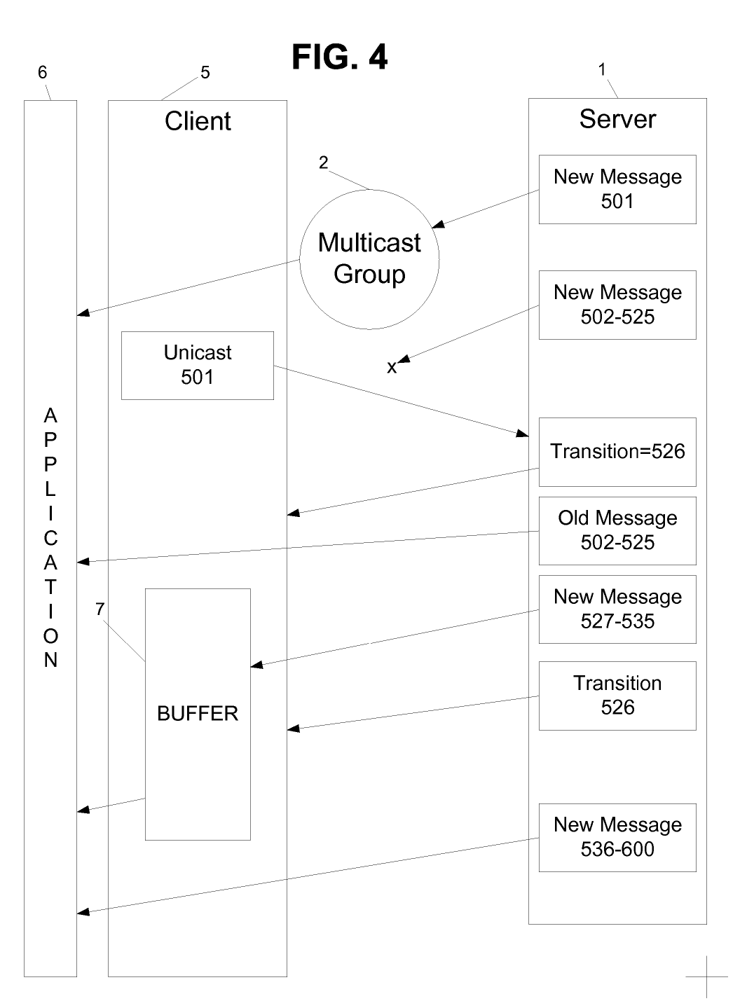

An example of a transition to unicast mode is shown in FIG. 4. In the example, message 501 is the last message received by the client 5 through the multicast group 2. Messages 502-525 are transmitted by the server 1 but not received. When this is detected by the client 5 it sends a message indicating the transition to unicast mode and the sequence of the last message received, 501. The server 1 responds with a transition sequence number, generated in the manner of those prepared for clients during their initial connection, in this example 526. The server 1 also moves the client 5 from the list of multicast clients to the list of unicast clients. The server 1 then retransmits the missed messages 502-525 which are received via unicast and immediately processed and sent to the application 6. New messages 527-535 are also sent via unicast and stored in a buffer 7. When the transition message 526 is received the messages in the buffer 7 are processed and sent to the application 6. At this point the client 5 is up-to-date and new messages 536-600 are then received via unicast and processed upon receipt.

In a volatile environment, a client 5 may initiate the transition between unicast and multicast mode numerous times with only a brief interval separating them. In such a situation a client 5 may have sent out several transition requests before receiving a response. However, this is not a problem for the system. Each time a client 5 begins a transition to multicast it stores the multicast data in a new buffer 7, and each transition request will be processed by the server 1 in the order in which it is received. As the multicast transitions are processed the contents of their respective buffers are processed as well, minimizing the amount of data that needs to be retransmitted. Eventually the network operating mode will stabilize or the session will end, and the client 5 will be up-to-date.

Occasionally the unicast connection from the client 5 to the server 1 will be lost due to a problem similar to those that might interfere with reception of multicast transmissions. Generally, the level of traffic required to cause a failure in a unicast connection would be greater than that which would disrupt multicast reception, close to the level of traffic indicative of a denial of service attack. Unicast connection problems can be detected through an error reported by the protocol or by heartbeat methods. Since unicast protocols are usually much better at detecting problems, it is probably sufficient to insure initial messages are exchanged within a few seconds thereby verifying the authenticity of the client 5 and server 1 to each other.

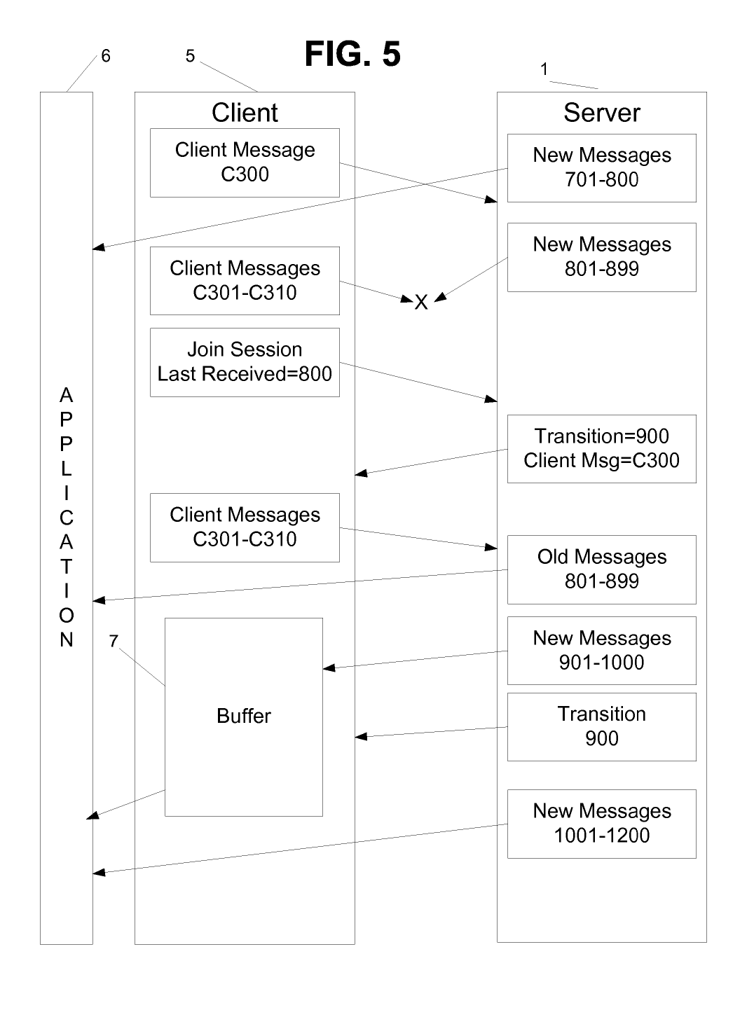

Whatever the cause, the procedure for recovering from a total loss of connectivity is shown in FIG. 5. In this example, the client 5 has successfully received messages 701-800 from the server 1, which for its part has received the client 5 generated message C300. Client 5 messages C301-C310 and server 1 generated messages 801-899 are lost. When the client 5 detects the connection failure, it will attempt to reconnect.

When the client 5 is successful in reconnecting it sends a join session message with the sequence number of the last message received, 800, in a manner similar to that of the initial connection, which is a special case of the reconnection protocol. The server 1 responds with its transition sequence number 900 along with the sequence number of the last client message received, C300. The client 5 responds by sending all the old messages C301-C310 the server 1 has not received before sending any new messages it generates.

If a client software or hardware failure has caused the client 5 to loose messages the server 1 received, the client 5 increases its current sequence number to that of the next message expected by the server. This may not be a problem for the application as the messages can be recovered from the server retransmissions. The server 1, to insure maximum reliability, may delay transmission of data until it is written to persistent storage so that clients will never receive messages that may be lost by a server which is later restarted. The server may periodically acknowledge the receipt of client messages, so that the client need not attempt to retain them for possible retransmission. The current client sequence number sent during reconnection is an implicit acknowledgement of those messages received before reconnection, but explicit acknowledgements may be sent every hundred messages or so depending on network and memory load. If client memory load is too high, an explicit acknowledgement may be requested.

The server 1 follows the transmission of the transition sequence number with the retransmission of old messages 801-899, transmission of new messages 901-1000 stored in the buffer 7 and the transition message 900 itself. The contents of the buffer 7 are processed by the client 5 and sent to the application 6. Finally, new messages 1001-1200 are processed upon receipt by the client 5 and immediately sent to the application 6.

While unusual, a client 5 may have lost its unicast connection to the server 1 while marinating a continuous multicast connection. If this is the case, the server 1 need only request any messages of the client 5 it does not have. Once the client 5 transmits those messages, it is up-to-date and resumes normal operation.

A client 5 experiencing connectivity problems may accumulate several buffers each with a different range of messages acquired during reception of new unicast or multicast data without becoming up-to-date. Upon reconnection the client 5 transmits the list of the buffered message ranges. The server 1 retransmits any data intended for the client 5 which is not part of those ranges, and sends a transition message whenever the data from a buffer 7 should be processed. The portion of any buffer 7 having sequence numbers below the transition message will be discarded. The server 1 keeps track of multicast transitions by clients which are not up-to-date in order to determine which multicast reception generated buffers must be discarded because the client 5 was on the unicast client list and may have missed messages sent to it via unicast. When all the buffers are processed the client 5 will be up-to-date, although if problems persist that may not be until the end of the session.

Upon session end a control message is sent and the multicast group 2 is closed. The server 1 may make continue to make the session data available for some time to allow clients to obtain any missing messages. Usually a few minutes is more than enough time to allow a client 5 to reconnect and receive the final messages, even if it experiences a problem toward the end of the session.

It is also possible for the server 1 to make the session data available indefinitely in a session archive that can be replayed on demand or at a prescheduled time. If such an archive is used, the same protocol may be employed, except that instead of having messages originate from the clients, they originate from the server's storage at a rate which may be based on the timing of the original messages or the amount of bandwidth available.

One possible limitation with the described system is that it may not scale to a large number of clients as they must all connect to the same server 1. In practice, a modern server 1 can handle the load typical of the collaborative sessions described. However, if desired several servers may be set up in a hierarchical fashion such that a primary server may connect using the protocol to a number of secondary servers who act as clients to the primary server. There may be any number of tiers of servers connected as clients to a higher tier including those secondary servers. These servers may be arranged as necessary to serve the desired number of clients. Such as system is scalable in its ability to deliver repair data and handle a large number of client connections.

The invention is particularly well suited to wireless local area networks, on such networks with speeds of nine megabytes per second, the system performs well when transmitting each multicast packet three times using forward error correction at a rate of one megabyte per second.

Typical applications include conferencing, application sharing, instruction, and collaborate inking.

The preferred embodiment of the invention is in the form of a software library which can be used by application developers. Developers need only define the custom message types and rules for their application and make use of the system for the transmission of data. In addition to the client side library, server side support may allow for various stations which generate, transform, or direct the transmission of messages.

Those skilled in the art can appreciate the invention may be embodied in other specific forms without departing from the spirit or essential character thereof. The disclosed embodiments are illustrative and not restrictive. The scope of the invention is indicated by the appended claims, rather than the foregoing description, and all changes which come within the meaning and range of equivalence thereof are intended to be embraced therein.

What is claimed is:

1. A system for exchanging shared data messages among devices:
over a period of time for a related purpose considered logically as a session;
provided the system includes a device designated as a server;
provided the system includes one or more devices designated as clients;
whereby the clients transmit messages to the server;
whereby the server orders messages received from the clients;
whereby the server transmits the ordered messages to a multicast group;
whereby clients attempt to establish and maintain a channel for receiving messages by joining the multicast group;
whereby the clients attempt to establish and maintain a channel for transmitting and receiving messages by means of a unicast connection to the server; and
whereby the system manages use of both the multicast and unicast channels to insure delivery of each message intended for a client application occurs exactly once and in a consistent order.

2. The system of claim 1 whereby all session messages intended for a client are delivered to a client joining the session an arbitrary period of time after the session is initiated.

3. The system of claim 1 whereby a set of destinations of a message may be specified from among the clients participating in the session.

4. The method of claim 3 whereby a destination is specified by using the identity of the user of the client.

5. The method of claim 3 whereby a destination is specified using a role of the client.

6. The method of claim 3 whereby the retransmission of messages over the unicast channel is limited to the messages where the client is included in the set of destinations.

7. The system of claim 1 whereby the multicast group operates using the pragmatic general multicast protocol.

8. The system of claim 1 whereby the unicast connection operates using the transmission control protocol.

9. The system of claim 1 whereby the server transmits messages via unicast to those clients unable to maintain a channel for receiving messages from the multicast group.

10. The system of claim 3 whereby unordered data destined for a particular client is sent over its unicast connection.

11. The system of claim 1 whereby upon reconnection of a client following a loss of connectivity new messages received by that client are held in a buffer until the lost messages can be retransmitted over the unicast connection.

12. The system of claim 11 whereby the sequence number of the message differentiating the new messages and lost messages is computed on the server between the transmission of successive blocks of messages for those clients waiting on a mutual exclusion construct when the transmission operation completed.

13. The system of claim 1 whereby a loss of connectivity is detected by means of heartbeat messages.

14. The system of claim 1 whereby the sessions are located by means of a session announcement protocol.

15. The system of claim 1 whereby the sessions are managed by a pervasive computing infrastructure.

16. The system of claim 1 where the messages are compressed.

17. The system of claim 1 where the messages are fragmented and reassembled.

18. The system of claim 1 where the messages are encrypted.

19. The system of claim 1 where the messages are digitally signed.

20. The system of claim 1 whereby the messages are ordered using a timestamp.

21. The system of claim 1 whereby the server is selected from among the client devices as one among several peers.

22. The system of claim 1 where the client device is a personal computer.

23. The system of claim 22 where the client device is a tablet computer.

24. The system of claim 1 where the client device is a personal digital assistant.

25. The system of claim 1 whereby the multicast addresses are obtained using the multicast address dynamic client allocation protocol.

26. The system of claim 1 thereby the session messages are retained beyond the conclusion of the session.

27. The system of claim 26 where the session messages are stored in an archive.

28. The system of claim 27 where the archival storage uses a database management system.

29. The system of claim 1 whereby the messages originate from an archival store.

30. The system of claim 29 whereby the playback rate is based on the original transmission rate.

31. The system of claim 29 whereby the playback rate is based on available bandwidth.

32. The system of claim 1 where the clients act as servers for other clients connected in a hierarchical fashion.

33. The system of claim 1 where it is used with a wireless network.

34. The system of claim 33 where it is used with a multicast transmission parameters such that each multicast packet is transmitted three times at a rate of one megabyte per second.

35. The system of claim 1 where it is used for conferencing.

36. The system of claim 1 where it is used for instruction.

37. The system of claim 1 where it is used for collaborative inking.

38. The system of claim 1 where it is used for application sharing.

39. The system of claim 1 whereby the functionality is embodied in a software library.

40. The system of claim 39 whereby the server-side support allows for various processing stations to generate, transform, or direct transmission of session messages.
